(19) United States
(12) Patent Application Publication
(10) Pub. No.: US 2026/0298649 A1
(43) Pub. Date: Oct. 1, 2026

(54) SYSTEMS AND METHODS FOR DISTRIBUTED FLEET ROUTING FOR VEHICLES

(71) Applicant: AVRIDE Inc., Newburyport, MA (US)

(72) Inventors: Dmitriy Baranov, Tel Aviv (IL); Roman Udovichenko, Austin, TX (US)

(21) Appl. No.: 19/577,619

(22) Filed: Mar. 25, 2026

Related U.S. Application Data
(60) Provisional application No. 63/777,149, filed on Mar. 25, 2025.

(51) Int. Cl. G01C 21/34; G01C 21/36

(52) U.S. Cl. CPC G01C 21/3492; G01C 21/3415; G01C 21/3446; G01C 21/3617; G01C 21/3691

(57) ABSTRACT

Provided herein is a system and method for distributed fleet routing for vehicles, the system including at least one processor; and a memory communicatively connected to the at least one processor, wherein the memory contains instructions configuring the at least one processor to: receive, from a fleet route database, a plurality of vehicle routes associated with a plurality of vehicles; receive a road map; project future locations for the plurality of vehicles based on the plurality of vehicle routes using a route density analyzer; update a cost value of one or more portions of the road map as a function of the projected future locations of the plurality of vehicles; generate an optimized route for a principal vehicle; and transmit the optimized route to the principal vehicle.

### CROSS REFERENCE TO RELATED APPLICATIONS

This application claims the benefit of priority to U.S. Provisional Application 63/777,149, filed on Mar. 25, 2025, and entitled DISTRIBUTED FLEET ROUTING OPTIMIZATION SYSTEM FOR AUTONOMOUS VEHICLES,” the entirety of which is incorporated herein by reference.

### FIELD OF THE INVENTION

The present invention is directed generally to route planning. Particularly, the present invention is directed to systems and methods for distributed fleet routing for vehicles.

### BACKGROUND OF THE INVENTION

Route planning for vehicles traditionally uses algorithms to find the shortest or fastest route to a destination or waypoint. However, existing solutions struggle when determining routes for a plurality of vehicles. For example, between a start and destination, there may be one optimal route. If every vehicle uses that same route, then they may cause traffic jams, thereby increasing the transit time of the route. If some cases, this may increase the transit time of the route to the point that alternative routes are actually more optimal. Therefore existing solutions are deficient in their goal of generating optimal routes when considering a plurality of vehicles.

Accordingly, there remains a need in the art for systems and methods for route generation that improve upon existing systems and methods for route generation. The present disclosure meets this need.

### SUMMARY

In some aspects, the techniques described herein relate to a system for distributed fleet routing for vehicles, the system including: at least one processor; and a memory communicatively connected to the at least one processor, wherein the memory contains instructions configuring the at least one processor to: receive, from a fleet route database, a plurality of vehicle routes associated with a plurality of vehicles, wherein each vehicle route of the plurality of vehicle routes includes: a route; a current location; and a destination; receive a road map; project future locations for the plurality of vehicles based on the plurality of vehicle routes using a route density analyzer; update a cost value of one or more portions of the road map as a function of the projected future locations of the plurality of vehicles; generate an optimized route for a principal vehicle, wherein generating the optimized route for the principal vehicle includes generating the optimized route as a function of the cost value for the one or more portions of the road map; and transmit the optimized route to the principal vehicle.

In some aspects, the techniques described herein relate to a method for distributed fleet routing for vehicles, the method including: receiving, from a fleet route database and using at least one processor, a plurality of vehicle routes associated with a plurality of vehicles, wherein each vehicle route of the plurality of vehicle routes includes: a route; a current location; and a destination; receiving, using the at least one processor, a road map; projecting, using the at least one processor, future locations for the plurality of vehicles based on the plurality of vehicle routes using a route density analyzer; updating, using the at least one processor, a cost value of one or more portions of the road map as a function of the projected future locations of the plurality of vehicles; generating, using the at least one processor, an optimized route for a principal vehicle, wherein generating the optimized route for the principal vehicle includes generating the optimized route as a function of the cost value for the one or more portions of the road map; and transmitting, using the at least one processor, the optimized route to the principal vehicle.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIGS. 1A and 1B show an exemplary embodiment of system for distributed fleet routing for vehicles;

FIGS. 2A and 2B show exemplary maps showing vehicle locations;

FIG. 3 shows an exemplary embodiment of a map graph 300;

FIGS. 4A and 4B show an exemplary vehicle computing architecture 400;

FIG. 5 shows an exemplary method for distributed fleet routing for vehicles; and

FIG. 6 shows a diagrammatic representation of an exemplary embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

### DETAILED DESCRIPTION

Provided herein is systems and methods for systems and methods for distributed fleet routing for vehicles. The present disclosure is directed to, in embodiments, a system and method for optimizing routing across a fleet of autonomous vehicles to minimize collective traffic congestion. Furthermore, the present disclosure may include a cloud-based coordination system.

The present disclosure, in embodiments, solves problems experienced with the prior art because it provides near-optimal routing efficiency for each vehicle while preventing artificial congestion caused by fleet vehicles following identical or overlapping. Existing solutions in this field are not sufficient because in optimizing vehicle routing, you do not necessarily want to follow shortest path. This is because, if a hole fleet or plurality of vehicles takes the same path, it may cause a traffic jam or otherwise cause congestion.

Those and other advantages and benefits of the present invention will become apparent from the detailed description of the invention hereinbelow.

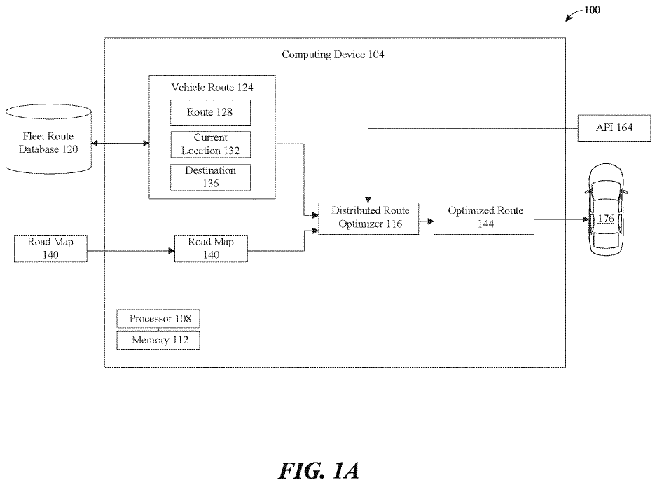

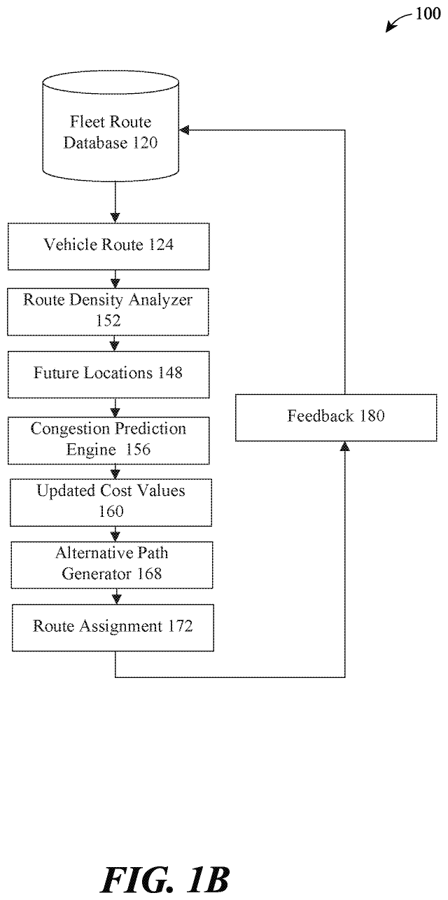

Referring now to FIGS. 1A and 1B, an exemplary embodiment of system 100 for distributed fleet routing for vehicles is illustrated. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIGS. 1A and 1B, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIGS. 1A and 1B, computing device 104 and/or distributed route optimizer 116 may be configured to run in the cloud. For example, computing device 104 and/or distributed route optimizer 116 may operate on a server. Data may be received from external data sources, APIs, vehicles, and the like, and processed on the server. Optimized routes may be generated on the server, then transmitted to vehicles for execution. External data may include, as non-limiting examples, traffic data, construction data, road closure data, and historical data. In some embodiments, computing device 104 may include real-time update system is incorporated within the cloud processing center to give live feedback.

With continued reference to FIGS. 1A and 1B, memory 112 may include instructions configuring processor 108 to receive, from a fleet route database 120, a plurality of vehicle routes 124. Fleet route database 120 may include routes 124 from a plurality of vehicles or a fleet of vehicles. In some embodiments, fleet route database 120 may be updated periodically or continuously, such that fleet route database 120 include updated, current routes 124 for vehicles.

With continued reference to FIGS. 1A and 1B, a Fleet route database 120 may be remote to computing device 104 and communicative with computing device 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure computing device 104 connect directly, dynamically, and non-hierarchically to as many other computing devices as possible. A “network topology” as used in this disclosure is an arrangement of elements of a communication network. Fleet route database 120 may be implemented, without limitation, as a relational database, a key-value retrieval database such as a NOSQL database, or any other format or structure for use as a database that a person skilled in the art would recognize as suitable upon review of the entirety of this disclosure. Fleet route database 120 may alternatively or additionally be implemented using a distributed data storage protocol and/or data structure, such as a distributed hash table or the like. Fleet route database 120 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, fleet route database 120 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain.

With continued reference to FIGS. 1A and 1B, vehicle route 124 may include a route 128. Route 128 is a pathway for a vehicle to take through a mapped area. Route 128 may include one or more roads for a vehicle to take, maneuvers to make, turns to make, and the like. Vehicle route 124 may include a current location 132. Current location 132 is the current location of the vehicle executing route 128. Current location 132 may include coordinates. Current location 132 may include latitude and longitude. Current location 132 may include a postal address. In some embodiments, vehicle route 124 may include a destination 136. Destination 136 may include a final destination of a vehicle executing route 128. Destination 136 may include in intermediate destination of a vehicle executing route 128 such as a waypoint, delivery stop, or taxi stop, as non-limiting examples.

With continued reference to FIGS. 1A and 1B, fleet route database 120 may include statistical information. For example, statistical information may include, average transit time, average speeds, average forces, energy efficiency, and the like. Historical data, is some embodiments, may include, historical transit time, a historical speeds, historical forces, historical energy efficiency, and the like.

With continued reference to FIGS. 1A and 1B, memory 112 may include instructions configuring processor 108 to receive a road map 140. A “road map,” for the purposes of this disclosure, is a digital map of a geographic areas. Road map 140 may include a geographic information system (GIS) file. A GIS file (Geographic Information System file) is a structured digital container that stores spatial data. Spatial data includes information about where things are on the within a space. A GIS file may also include descriptive information about what objects are and how they relate to one another.

With continued reference to FIGS. 1A and 1B, the spatial data of GIS file may define the shape and position of features. These features may be represented as points (such as trees or traffic lights), lines (such as roads or rivers), or polygons (such as buildings or lakes). Each geometric object may be stored as a set of coordinates within a defined coordinate reference system. The GIS file may also include an attribute table. This may be structured similarly to a database table or spreadsheet. Each row may correspond to a specific spatial feature; each column may represent a property of that feature. As a non-limiting example, a road feature might include attributes such as name, speed limit, number of lanes, and surface type. As a non-limiting example, building feature might include height, address, and usage classification. The geometry and the attribute table may be linked internally through feature identifiers, allowing GIS software to associate descriptive information with precise spatial locations.

With continued reference to FIGS. 1A and 1B, in some embodiments, GIS files may also store topology. Topology may describes how features relate to one another spatially. Topological information may define connectivity (which roads intersect), adjacency (which polygons share boundaries), and/or containment (which features lie within others).

With continued reference to FIGS. 1A and 1B, GIS files may include one or more data layers. Data layers may include, as non-limiting examples, transportation layers, boundary layers, landmark layers, water feature layers, elevation layers, and satellite imagery layers. In some embodiments, GIS files may include one or more of the forgoing layers.

With continued reference to FIGS. 1A and 1B, road map 140 may include or be converted into a graph. The graph may include a plurality of nodes and a plurality of edges. Nodes may represent intersections, roads, or any other paths accessible to a vehicle. Edges may represent road or path segments between the nodes (intersections). For example, an edge may represent a road segment between a first intersection and a second intersection.

With continued reference to FIGS. 1A and 1B, edges may have one or more associated properties. Properties may include, as non-limiting examples, length, speed limits, road types, projected vehicle occupancy, turn restrictions, number of lanes, historical travel time, or the like. In some embodiments, properties may include properties for different times of day. As a non-limiting example, historical travel times may include historical travel times for different times of day.

With continued reference to FIGS. 1A and 1B, each edge may be assigned a cost. A cost is a mathematical representation of a cost of using the edge. As a non-limiting example, a cost for an edge may include a historical travel time. As a non-limiting example, a cost for an edge may include a distance. As a non-limiting example, a cost for an edge may include a projected vehicle occupancy.

With continued reference to FIGS. 1A and 1B, memory 112 may include instructions configuring processor 108 to generate an optimized route 144 using distributed route optimizer 116. Distributed route optimizer 116 is shown with more detail in FIG. 1B.

With continued reference to FIGS. 1A and 1B, memory 112 may include instructions configuring processor 108 to project future locations 148 for the plurality of vehicles based on the plurality of vehicle routes 124 using a route density analyzer 152. In some embodiments, projecting the future locations 148 for the plurality of vehicles based on the plurality of vehicle routes 124 using the route density analyzer 152 comprises projecting the future locations 148 for the plurality of vehicles at a series of temporal displacements into the future.

With continued reference to FIGS. 1A and 1B, projecting the future locations 148 for the plurality of vehicles at a series of temporal displacements into the future may include projecting future locations using route geometry. In some embodiments, projecting the future locations 148 for the plurality of vehicles at a series of temporal displacements into the future may include projecting future locations using estimated times of arrival (ETAs). For example, if a vehicle has an ETA in 30 minutes, then route density analyzer 152 may project that the vehicle's future position in 15 minutes will be 50% of the way geometrically along the route. As another example, if a vehicle has an ETA in 50 minutes, then route density analyzer 152 may project that the vehicles future position in 5 minutes will be 10% of the was geometrically along the route. This may take into account the geometric path of the route when determining the future distance, rather than a straight distance to the destination.

With continued reference to FIGS. 1A and 1B, route density analyzer 152 may be configured to calculate where they are going to be as non-limiting examples, in 5, 10, 15 minutes based on ETA and road geometry. In some embodiments, route density analyzer 152 may be configured to generate future locations 148 for vehicles at 5 minute intervals. In some embodiments, route density analyzer 152 may be configured to generate future locations 148 for vehicles at 10 minute intervals. In some embodiments, route density analyzer 152 may be configured to generate future locations 148 for vehicles at 15 minute intervals.

With continued reference to FIGS. 1A and 1B, future locations 148 may be passed through to a congestion prediction engine 156. Congestion prediction engine 156 may determine updated cost values 160 using the future locations 148.

With continued reference to FIGS. 1A and 1B, memory 112 may include instructions configuring processor 108 to update a cost value of one or more portions of the road map as a function of the projected future locations 148 of the plurality of vehicles. The cost value may represent a penalty for using that portion of road map 140. For example if a vehicle is projected to be using that portion of roadmap, then a cost value may be increased to discourage the use of that road. This represents a technical improvement over the prior art because it allows for route generation for autonomous vehicles that automatically coordinates the routes of the vehicles to take into account their overlap and prevent traffic jams and unneeded congestion. The updated cost values 160 may represent a penalty. Depending on the congestion prediction of congestion prediction engine 156 cost values may be updated to penalize the use of predicted congested roads or segments of roads.

With continued reference to FIGS. 1A and 1B, in some embodiments, updating the cost value of the one or more portions of the road map 140 as a function of the projected future locations of the plurality of vehicles may include updating the cost value of at least an edge of the plurality of edges. An edge may represent, as non-limiting examples, road, road segment, path, path segment, or the like.

With continued reference to FIGS. 1A and 1B, in some embodiments, updating the cost value of the one or more portions of the road map 140 may include updating the cost value of the one or more portions of the road map 140 as a function of historical transit time data associated with the one or more portions of the road map to increase the cost value of portions of the road map associated with higher historical transit time. In some embodiments, historical transit time data may be retrieved from fleet route database 120. In some embodiments, historical transit time data may be retrieved from a map database. Historical transit times may be collected from historical trips. Historical transit times may include previous transits of a particular road segment. Historical transit times may include averaged historical data.

With continued reference to FIGS. 1A and 1B, in some embodiments, updating the cost value of the one or more portions of the road map 140 may include updating the cost value of the one or more portions of the road map 140 as a function of current data associated with the one or more portions of the road map. In some embodiments, current data may be retrieved from fleet route database 120. In some embodiments, current data may be retrieved from a map database. Current data may include, as non-limiting examples, construction data, road closures, accident data, and the like. In some embodiments, current data may include real-time data. In some embodiments, current data may be received through a traffic jam API. Traffic jam API may include, as a non-limiting example, WAZE, GOOGLE MAPS, APPLE MAPS, or the like.

With continued reference to FIGS. 1A and 1B, current data may be received through an application protocol interface (API) 164. In some embodiments, updating the cost value of the one or more portions of the road map 140 may include receiving real-time traffic data through a traffic application programming interface (API) 164.

With continued reference to FIGS. 1A and 1B, updating the cost value of the one or more portions of the road map 140 as a function of the real-time traffic data associated with the one or more portions of the road map to increase the cost value of portions of the road map associated with higher traffic data. For example, areas with higher traffic may be assigned a higher cost value.

With continued reference to FIGS. 1A and 1B, updated cost values 160 may be determined as a function of a number of lanes. For example, a narrow street may have less possible throughput than a highway.

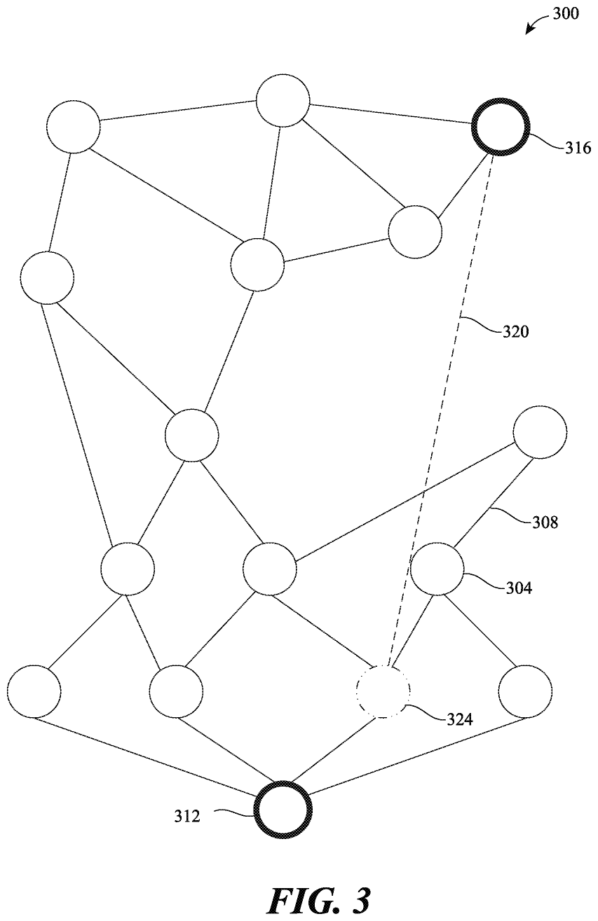

With continued reference to FIGS. 1A and 1B, updated cost values 160 may be used by alternative path generator 168 to generate a route assignment 172. In some embodiments, generating a route assignment 172 may include generating a plurality of alternative paths. Memory 112 may include instructions configuring processor 108 to generate an optimized route for a principal vehicle, wherein generating the optimized route for the principal vehicle comprises generating the optimized route 144 as a function of the cost value for the one or more portions of the road map 140. Alternative path generator 168 may be configured to use routing algorithms as described further with respect to FIG. 3.

With continued reference to FIGS. 1A and 1B, generating the optimized route for the principal vehicle may further include calculating a total cost for a candidate route, wherein calculating the total cost for the candidate route comprises adding the costs associated with each edge in the candidate route.

With continued reference to FIGS. 1A and 1B, generating the optimized route for the principal vehicle further comprises generating a plurality of alternate routes. In some embodiments, generating the alternative routes may include generating a plurality of routes. In some embodiments, generating the alternative routes may include select a set of shortest time routes of the plurality of routes. Shortest time routes as the routes with the shortest projected duration. In some embodiments, set of shortest time rouses may include the five shortest time routes. In some embodiments, set of shortest time rouses may include the 10 shortest time routes. In some embodiments, set of shortest time rouses may include the 15 shortest time routes. In some embodiments, alternative path generator 168 may include three alternative candidates. In some embodiments, alternative path generator 168 may include five alternative candidates. In some embodiments, alternative path generator 168 may include 10 alternative candidates. In some embodiments, alternative candidates may be generated by altering the algorithms trade off between time and distance. For example, algorithm may decrease the penalty associated with longer times compared to distance.

With continued reference to FIGS. 1A and 1B, if the generated route does not intersect any vehicle routes 124, then that route may be used as optimized route 144. In some embodiments, if there are intersections with other vehicle routes 124, then alternative paths may be considered. In some embodiments, at points where there are intersections with other vehicle routes 124, computing device 104 may be configured to add an additional cost to the segment of road map 140 associated with the intersection and then generate alternative routes using the updated cost values.

With continued reference to FIGS. 1A and 1B, in some embodiments, memory 112 may include instructions configuring processor 108 to transmit optimized route 144 to a principal vehicle 176. The “principle vehicle,” for the purposes of this disclosure, is the vehicle that the optimized route was generated for. In some embodiments, principal vehicle 176 may include an autonomous car. Autonomous car may include, as non-limiting examples, a self-driving car, a robotaxi, and the like.

With continued reference to FIGS. 1A and 1B, in some embodiments, principal vehicle 176 may include a robot. In some embodiments, 176 may include a delivery robot. In the context of delivery robots, system 100 may serve a parking reservation management system. For example, route density analyzer 152 may predict if the robots will be at a parking area at the same time. In some embodiments, where there is a limited number of parking spaces, you would not want all of the robots to go to the same location. In some embodiments, alternative path generator 168 may be configured to, using route density analyzer 152 and congestion prediction engine 156, route the delivery robot to an open parking space (or a space that will become open). In some embodiments, this parking space algorithm may be triggered when principal vehicle 176 is close to the destination. In some embodiments, system 100 may communicate with other vehicles to track whether parking spots are occupied or have become open.

With continued reference to FIGS. 1A and 1B, transmitting optimized route 144 to principal vehicle 176 may include using wireless communication. Wireless communication may include, as non-limiting examples, cellular communication, 2G, 3G, 4G, LTE, 5G, EDGE, Radio, line of sight, WiFi, and the like.

With continued reference to FIGS. 1A and 1B, in some embodiments, system 100 may include feedback 180 to improve and update the generation of optimized route 144. To make better ETA predictions, system 100 may continuously record statistics for how long it takes to go from point one to point two and the time of day. This data may be collected by vehicle and principal vehicle 176 as they execute routes and then fed back into system 100 using a feedback 180 loop; for example, this data may be stored and updated in fleet route database 120. System may periodically recalculate future locations 148 and/or a heatmap of future locations 148 using feedback

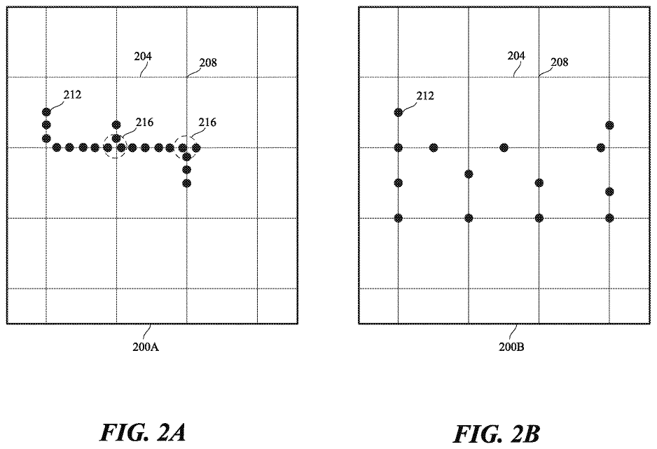

Referring now to FIG. 2A, an exemplary map 200A showing vehicle locations is shown. Map 200A represents a map of vehicles when not using the route optimization algorithms described in this disclosure. Map 200A shows a network of roads 204 and intersections 208 consistent with a road network. Roads 204 may include any paths traversable by a vehicle. Roads 204 may include, as non-limiting examples, paths, bike paths, walking paths, streets, highways, roads, parkways, turnpikes, toll roads, alleys, and the like. Intersections 208 are any intersections between one or more roads 204. Intersections may include, as non-limiting examples, traffic light metered intersections, stop signs, roundabouts, exits, merges, and the like.

With continued reference to FIG. 2A, map 200A may include a plurality of vehicles 212. Plurality of vehicles 212 may include autonomous vehicles, autonomous cars, delivery robots, or the like, as described further above. Plurality of vehicles 212 are shown using dots on map 200A to signify the location of the vehicles 212.

With continued reference to FIG. 2A, using an suboptimal route generation algorithm, for example a conventional route generation algorithm, vehicle routes may have substantial overlap as many vehicles may be funneled through the same road or intersection. This may cause traffic jams 216. Traffic jams 216 may include a plurality of vehicles trying to fit through one road or intersection, thereby causing a backup and increasing transit times. This is suboptimal and a result of using conventional route generation algorithms.

Referring now to FIG. 2B, a map 200B showing vehicle locations is shown. Map 200A represents a map of vehicles using the route optimization algorithms described in this disclosure, particularly with reference to FIGS. 1A and 1B. 200B includes roads 204, intersections 208, and plurality of vehicles 212 consistent with FIG. 2A.

With continued reference to FIG. 2B, map 200B using the improved fleet route generation algorithms described in this disclosure does not include traffic jams 216. This may be the case at least because each of plurality of vehicles 212 take into account the route of other vehicles 212. Therefore, using the methods described with reference to FIGS. 1A-1B and FIG. 3, the algorithms take into account the future positions of plurality of vehicles 212 therefore generating routes that minimize traffic jams 216.

Referring now to FIG. 3, a map graph 300 is shown. Map graph 300 may include a graphical representation of road map 140. For example, map graph 300 may include a plurality of nodes 304. Nodes 304 may represent various intersections as described throughout this disclosure. Map graph 300 may include a plurality of edges 308. Plurality of edges 308 may connect plurality of nodes 304 together. Plurality of edges 308 may represent various roads or pathways between plurality of nodes 304. For example, an edge 308 connecting a first node to a second node may represent a road going between two intersections. Thus, in the map graph 300 context, each edge 308 is a pathway that a vehicle could take in between plurality of nodes 304.

With continued reference to FIG. 3, to generate a route, memory may include instructions configuring processor to use a graph search algorithm. A graph search algorithm systematically explores connections (i.e. edges) between nodes to find information, uncover patterns, and/or determine optimal paths. For example, graph search algorithm may be configured to traverse the edges (e.g. roads) and nodes (e.g., intersections) to find an optimal or otherwise desired route between selected nodes. In some embodiments, graph search algorithm may be configured to track visited nodes and decide which node to next visit between the unvisited nodes.

With continued reference to FIG. 3, map graph 300 may include a start node 312. Start node 312 may include a beginning point or a current location for a vehicle for which a route is sought. In some embodiments, map graph 300 may include an end node 316. End node 316 may include a destination for a vehicle or a next waypoint or stop point. For example, end node 316 may include a parking spot or destination for a rider. In some embodiments, map search algorithm may be configured to determine an optimal route between start node 312 and end node 316.

With continued reference to FIG. 3, in some embodiments, graph search algorithm may include an informed search algorithm. In some embodiments, graph search algorithm may include an A* (A-star) search algorithm. A* may improve speed over a standard graph search algorithm by, for example, using a heuristic 320 to guide the search. The heuristic 320 may include, for example, a straight line distance to the destination. A* may determine which node to progress to based on the formula:

$$f ( n ) = g ( n ) + h ( n )$$

g(n) may represent the cost from a start node to node n. Node n may be current node 324. For example, start node 312 may include a current position of a vehicle or a start waypoint. Node n is the current node 324 being evaluated by the algorithm. In thee embodiments, g(n) may include the updated cost values 160 described above in order to implement the improved algorithms described in this disclosure. h(n) may represent an estimated cost, using the heuristic, from node n to the goal. Goal may include the destination for a vehicle. Using this function, A* may determined an estimated cost f(n). Then, A* may move to the node with the lowest f(n) and repeat this process for nodes adjacent to the new node.

With continued reference to FIG. 3, graph search algorithm may include Dijkstra's Algorithm. Dijkstra's algorithm may be configured to expand the unvisited node with the smallest distance from the current node. For each neighbor of the new node, the algorithm may determine a distance comprising the current distance added to the edge weight of the node. If this determined distance is smaller than the neighbor nodes recorded distance, then the algorithm may record that the best path goes through the current node.

With continued reference to FIG. 3, graph search algorithm may be configured to generate routes with the shortest distance. Graph search algorithm may be configured to generate routes with the shortest travel time. Graph search algorithm may be configured to generate routes with the least traffic.

With continued reference to FIG. 3, graph search algorithm may include a breadth-first search (BFS). BFS may be configured to explore all nodes at the present depth prior to moving on to the nodes at the next depth level. Extra memory, usually a queue, is needed to keep track of the child nodes that were encountered but not yet explored.

With continued reference to FIG. 3, graph search algorithm may include a depth-first search (DFS) algorithm. The DFS algorithm may start at the root node (selecting some arbitrary node as the root node in the case of a graph) and explore as far as possible along each branch before backtracking to investigate other branches. Extra memory, usually a stack, is needed to keep track of the nodes discovered so far along a specified branch which helps in backtracking of the graph.

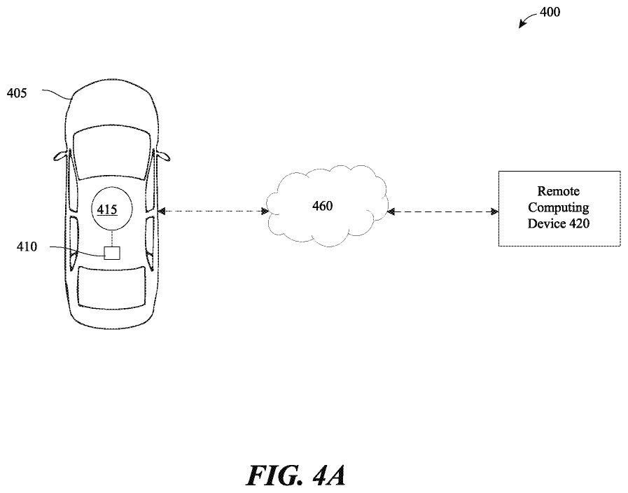

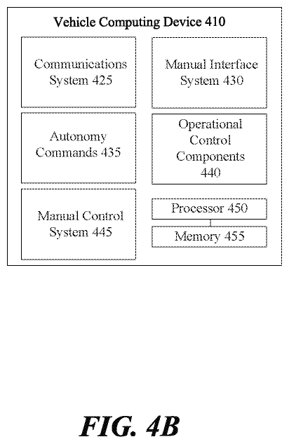

Referring now to FIGS. 4A and 4B, an exemplary vehicle computing architecture 400 is shown. Vehicle computing architecture 400 may include a vehicle 405. A “vehicle,” for the purposes of this disclosure is a device that is designed to transport goods, people, and/or animals. In some embodiments, vehicle 405 may be motorized. As non-limiting examples, vehicle 405 may include a car, a scooter, an ebike, an ATV, a motorcycle, a motorbike, a minibike, a truck, a golf cart, an aircraft, and the like. In some embodiments, vehicle 405 may be human-powered. As non-limiting examples, vehicle 405 may include a bike, a rickshaw, a skateboard, a scooter, or the like.

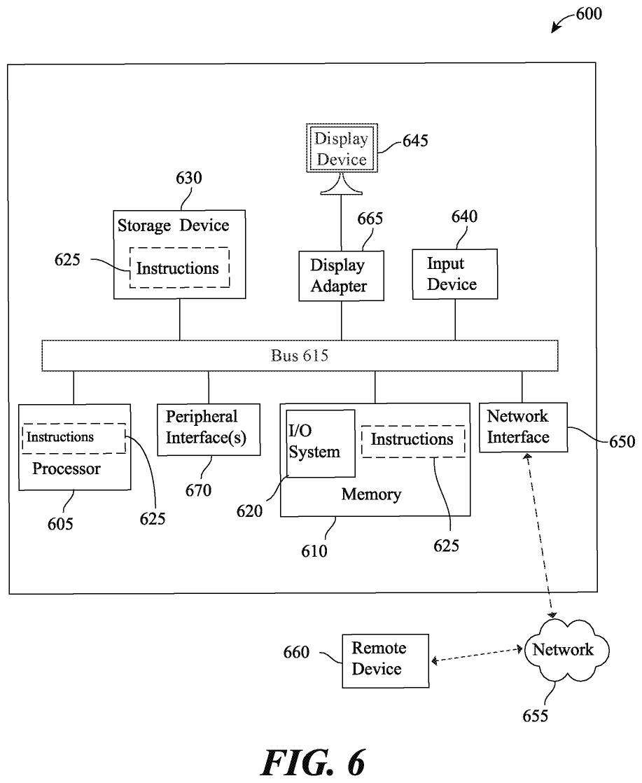

With continued reference to FIGS. 4A AND 4B, the vehicle 405 may be an autonomous vehicle that may drive, navigate, operate, etc. with minimal and/or no interaction from a human driver. Vehicle 405 may include a vehicle computing device 410 that implements a variety of systems on-board the vehicle 405. In some embodiments, vehicle computing device 410 may be consistent with aspects of computing device 600 described further with respect to FIG. 6.

With continued reference to FIGS. 4A and 4B, in some embodiments, vehicle computing architecture 400 may include one or more data acquisition systems 415. A data acquisition systems 415 may include a plurality of sensors configured to detect data from the environment surrounding or inside of vehicle 405. In some embodiments, data acquisition system 415 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 415 may include one or more LIDAR sensors. In some embodiments, data acquisition system 415 may include one or more ultrasound sensors. For example, ultrasound sensors may be mounted around the perimeter of vehicle 405. In some embodiments, ultrasound sensors may be located on the corners of vehicle 405. In some embodiments, ultrasound sensors may be used for object detection and/or collision avoidance. In some embodiments, data acquisition system 415 may include one or more microphones. In some embodiments, microphones may be arranged in an array. In some embodiments, microphones may include directional microphones. In some embodiments, microphones may include unidirectional microphones. In some embodiments data acquisition system 415 may include one or more RADAR sensors. In some embodiments, data acquisition system 415 may include, as non-limiting examples, lane detectors, optical readers, electric eyes, and/or other suitable types of image capture devices.

With continued reference to FIGS. 4A and 4B, vehicle computing device 410 may include a plurality of vehicle computing devices 410. As a non-limiting example, in some embodiments, vehicle computing device 410 may include, a central computing device and one or more auxiliary computing devices. In some embodiments, auxiliary computing devices may be located on or in the vehicle 405 roof. In some embodiments, auxiliary computing devices may be located close to certain sensors of data acquisition system 415 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 4A and 4B, the vehicle 405 may be configured to enter into a ready state. The ready state may indicate that the vehicle 405 is ready to operate (and/or return to) an autonomous navigation mode. A computing device on-board the vehicle 405 may be configured to determine whether the vehicle 405 is in the ready state. A remote computing device 420 (e.g., associated with an operations control center) may indicate that the vehicle 405 is ready to begin and/or resume autonomous navigation.

With continued reference to FIGS. 4A and 4B, for instance, the vehicle computing system 410 may include a communications system 425, one or more manual interface systems 430, one or more data acquisition systems 415, an autonomy command 435, one or more operational control components 440, and/or a manual control system 445.

With continued reference to FIGS. 4A and 4B, the manual interface systems 430 may be configured to allow interaction between a user (e.g., human) and the vehicle 405 (e.g., the vehicle computing system 410). The manual interface systems 430 may include a variety of interfaces for the user to input and/or receive information from the vehicle computing system 410. The manual interface systems 430 may include one or more input device(s) (e.g., touchscreens, keypad, touchpad, knobs, buttons, sliders, switches, mouse, gyroscope, microphone, other hardware interfaces) configured to receive user input. The manual interface systems 430 may include a user interface (e.g., graphical user interface, conversational and/or voice interfaces, chatter robot, gesture interface, other interface types) for receiving user input.

With continued reference to FIGS. 4A and 4B, vehicle computing system 410 may include a processor 450 and a memory 455. Processor 450 and memory 455 may be consistent with other processors and memory described throughout this disclosure. Processor 450 and memory 455 may be communicatively connected. Memory 455 may contain instructions (e.g., software) configured to cause processor 450 to perform one or more actions in accordance with this disclosure.

With continued reference to FIGS. 4A and 4B, vehicle computing architecture 400 may include a remote computing device 420. the remote computing device 420 may include and/or otherwise be associated with one or more computing devices (e.g., computing device 600, referred to in FIG. 6 that are remote from the vehicle 405. The remote computing device 420 may communicate with the vehicle 405 via one or more communications networks 460. The communications network 460 may include various wired and/or wireless communication mechanisms (e.g., cellular, wireless, satellite, microwave, and radio frequency) and/or any desired network topology. For example, the communications network 460 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 405.

The systems and methods described in this disclosure may be allow for AB testing of different software, cars, sensor sets, or the like. For example, in some embodiments, a route may be generated and sent to cars with different software. Therefore, the software (or other different parameter) may be AB tested. In some embodiments, systems and methods described herein may validate new world maps. For examples, routes may be generated between waypoints within a pool of waypoints in order to test said waypoints. This may include a map regression check. This is otherwise not possible without such system (unless you ride over the whole map in real car). This saves a lot of time, and allows for validation scale easily (this may be because you don't need to spend time on testing in real world for every new map version) and therefore deliver map updates faster.

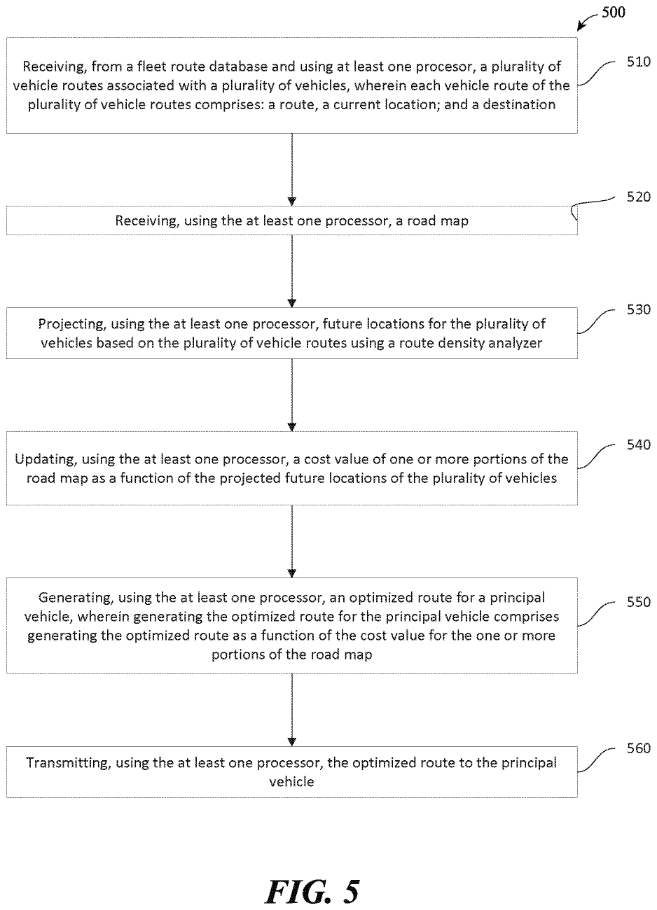

Referring now to FIG. 5, an exemplary embodiment of a method 500 for distributed fleet routing for vehicles is shown. Method 500 may include a step 510 of receiving, from a fleet route database and using at least one processor, a plurality of vehicle routes associated with a plurality of vehicles, wherein each vehicle route of the plurality of vehicle routes includes: a route; a current location; and a destination. This may be performed, without limitation, as described with reference to any of FIGS. 1-4B.

With continued reference to FIG. 5, method 500 may include a step 520 of receiving, using the at least one processor, a road map. This may be performed, without limitation, as described with reference to any of FIGS. 1-4B.

With continued reference to FIG. 5, method 500 may include a step 530 of projecting, using the at least one processor, future locations for the plurality of vehicles based on the plurality of vehicle routes using a route density analyzer. This may be performed, without limitation, as described with reference to any of FIGS. 1-4B.

With continued reference to FIG. 5, method 500 may include a step 540 of updating, using the at least one processor, a cost value of one or more portions of the road map as a function of the projected future locations of the plurality of vehicles. This may be performed, without limitation, as described with reference to any of FIGS. 1-4B.

With continued reference to FIG. 5, method 500 may include a step 550 of generating, using the at least one processor, an optimized route for a principal vehicle, wherein generating the optimized route for the principal vehicle includes generating the optimized route as a function of the cost value for the one or more portions of the road map. This may be performed, without limitation, as described with reference to any of FIGS. 1-4B.

With continued reference to FIG. 5, method 500 may include a step 560 of transmitting, using the at least one processor, the optimized route to the principal vehicle. This may be performed, without limitation, as described with reference to any of FIGS. 1-4B.

In some aspects, the techniques described herein relate to a method, wherein projecting the future locations for the plurality of vehicles based on the plurality of vehicle routes using the route density analyzer includes projecting the future locations for the plurality of vehicles at a series of temporal displacements into the future.

In some aspects, the techniques described herein relate to a method, wherein: the road map includes: a plurality of nodes; and a plurality of edges connecting the nodes; and updating the cost value of the one or more portions of the road map as a function of the projected future locations of the plurality of vehicles further includes updating the cost value of at least an edge of the plurality of edges.

In some aspects, the techniques described herein relate to a method, wherein generating the optimized route for the principal vehicle further includes calculating a total cost for a candidate route, wherein calculating the total cost for the candidate route includes adding the costs associated with each edge in the candidate route.

In some aspects, the techniques described herein relate to a method, wherein updating the cost value of the one or more portions of the road map includes updating the cost value of the one or more portions of the road map as a function of historical transit time data associated with the one or more portions of the road map to increase the cost value of portions of the road map associated with higher historical transit time.

In some aspects, the techniques described herein relate to a method, wherein updating the cost value of the one or more portions of the road map includes: receiving real-time traffic data through a traffic application programming interface (API); updating the cost value of the one or more portions of the road map as a function of the real-time traffic data associated with the one or more portions of the road map to increase the cost value of portions of the road map associated with higher traffic data.

In some aspects, the techniques described herein relate to a method, wherein generating the optimized route for the principal vehicle further includes generating a plurality of alternate routes, wherein generating the plurality of alternate routes includes: generating a plurality of routes; and select a five shortest time routes of the plurality of routes.

In some aspects, the techniques described herein relate to a method, wherein principal vehicle includes a delivery robot.

In some aspects, the techniques described herein relate to a method, wherein the principal vehicle includes an autonomous vehicle.

In some aspects, the techniques described herein relate to a method, wherein generating the optimized route as a function of the cost value for the one or more portions of the road map includes generating the optimized route using an A-star algorithm.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 605 and a memory 610 that communicate with each other, and with other components, via a bus 615. Bus 615 may include any of several types of bus structures including, but not limited to, a memory bus, a memory controller, a peripheral bus, a local bus, and any combinations thereof, using any of a variety of bus architectures.

Processor 605 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 605 may be organized according to Von Neumann and/or Harvard architecture as a non-limiting example. Processor 605 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 610 may include various components (e.g., machine-readable media) including, but not limited to, a random-access memory component, a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof. Memory 610 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 600 may also include a storage device 630. Examples of a storage device (e.g., storage device 630) include, but are not limited to, a hard disk drive, a magnetic disk drive, an optical disc drive in combination with an optical medium, a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 (or one or more components thereof) may be removably interfaced with computer system 600 (e.g., via an external port connector (not shown)). Particularly, storage device 630 and an associated machine-readable medium may provide nonvolatile and/or volatile storage of machine-readable instructions, data structures, program modules, and/or other data for computer system 600. In some embodiments, storage device 630 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 625) may reside, completely or partially, within machine-readable medium. In another example, software may reside, completely or partially, within processor 605.

Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof. Input device 640 may include a touch screen interface that may be a part of or separate from display 645, discussed further below. Input device 640 may be utilized as a user selection device for selecting one or more graphical representations in a graphical interface as described above.

A user may also input commands and/or other information to computer system 600 via storage device 630 (e.g., a removable disk drive, a flash drive, etc.) and/or network interface device 650. A network interface device, such as network interface device 650, may be utilized for connecting computer system 600 to one or more of a variety of networks, such as network 655, and one or more remote devices 660 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 655, may employ a wired and/or a wireless mode of communication. In general, any network topology may be used. Information (e.g., data, software, etc.) may be communicated to and/or from computer system 600 via network interface device 650.

Computer system 600 may further include a video display adapter 665 for communicating a displayable image to a display device, such as display 645. Examples of a display device include, but are not limited to, a liquid crystal display (LCD), a cathode ray tube (CRT), a plasma display, a light emitting diode (LED) display, and any combinations thereof. Display adapter 665 and display 645 may be utilized in combination with processor 605 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof.

Further referring to FIG. 6, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 6, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 6, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 600, processor 605, and memory 610 may be virtualized; that is, a virtual machine and/or container may interact directly with such computing system 600, processor 605, and/or memory 610, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 605 comprises a plurality of processors and/or processor cores, virtualization may, in some cases, simulate or emulate a single (virtual) processor whose functions are allocated to one or more of the plurality of processors and/or processor cores. In this case, while processor 605 may be said to be virtualized, the processor 605, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular systems and methods used to implement the disclosure may be modified without changing the spirit of the disclosure and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for distributed fleet routing for vehicles, the system comprising:
at least one processor; and
a memory communicatively connected to the at least one processor, wherein the memory contains instructions configuring the at least one processor to:
receive, from a fleet route database, a plurality of vehicle routes associated with a plurality of vehicles, wherein each vehicle route of the plurality of vehicle routes comprises:
a route;
a current location; and
a destination;
receive a road map;
project future locations for the plurality of vehicles based on the plurality of vehicle routes using a route density analyzer;
update a cost value of one or more portions of the road map as a function of the projected future locations of the plurality of vehicles;
generate an optimized route for a principal vehicle, wherein generating the optimized route for the principal vehicle comprises generating the optimized route as a function of the cost value for the one or more portions of the road map; and
transmit the optimized route to the principal vehicle.

2. The system of claim 1, wherein projecting the future locations for the plurality of vehicles based on the plurality of vehicle routes using the route density analyzer comprises projecting the future locations for the plurality of vehicles at a series of temporal displacements into the future.

3. The system of claim 1, wherein:
the road map comprises:
a plurality of nodes; and
a plurality of edges connecting the nodes; and
updating the cost value of the one or more portions of the road map as a function of the projected future locations of the plurality of vehicles further comprises updating the cost value of at least an edge of the plurality of edges.

4. The system of claim 3, wherein generating the optimized route for the principal vehicle further comprises calculating a total cost for a candidate route, wherein calculating the total cost for the candidate route comprises adding the costs associated with each edge in the candidate route.

5. The system of claim 3, wherein updating the cost value of the one or more portions of the road map comprises updating the cost value of the one or more portions of the road map as a function of historical transit time data associated with the one or more portions of the road map to increase the cost value of portions of the road map associated with higher historical transit time.

6. The system of claim 3, wherein updating the cost value of the one or more portions of the road map comprises:
receiving real-time traffic data through a traffic application programming interface (API);
updating the cost value of the one or more portions of the road map as a function of the real-time traffic data associated with the one or more portions of the road map to increase the cost value of portions of the road map associated with higher traffic data.

7. The system of claim 1, wherein generating the optimized route for the principal vehicle further comprises generating a plurality of alternate routes, wherein generating the plurality of alternate routes comprises:
generating a plurality of routes; and
select a five shortest time routes of the plurality of routes.

8. The system of claim 1, wherein principal vehicle comprises a delivery robot.

9. The system of claim 1, wherein the principal vehicle comprises an autonomous vehicle.

10. The system of claim 1, wherein generating the optimized route as a function of the cost value for the one or more portions of the road map comprises generating the optimized route using an A-star algorithm.

11. A method for distributed fleet routing for vehicles, the method comprising:
receiving, from a fleet route database and using at least one processor, a plurality of vehicle routes associated with a plurality of vehicles, wherein each vehicle route of the plurality of vehicle routes comprises:
a route;
a current location; and
a destination;
receiving, using the at least one processor, a road map;
projecting, using the at least one processor, future locations for the plurality of vehicles based on the plurality of vehicle routes using a route density analyzer;
updating, using the at least one processor, a cost value of one or more portions of the road map as a function of the projected future locations of the plurality of vehicles;
generating, using the at least one processor, an optimized route for a principal vehicle, wherein generating the optimized route for the principal vehicle comprises generating the optimized route as a function of the cost value for the one or more portions of the road map; and
transmitting, using the at least one processor, the optimized route to the principal vehicle.

12. The method of claim 11, wherein projecting the future locations for the plurality of vehicles based on the plurality of vehicle routes using the route density analyzer comprises projecting the future locations for the plurality of vehicles at a series of temporal displacements into the future.

13. The method of claim 11, wherein:
the road map comprises:
a plurality of nodes; and
a plurality of edges connecting the nodes; and
updating the cost value of the one or more portions of the road map as a function of the projected future locations of the plurality of vehicles further comprises updating the cost value of at least an edge of the plurality of edges.

14. The method of claim 13, wherein generating the optimized route for the principal vehicle further comprises calculating a total cost for a candidate route, wherein calculating the total cost for the candidate route comprises adding the costs associated with each edge in the candidate route.

15. The method of claim 13, wherein updating the cost value of the one or more portions of the road map comprises updating the cost value of the one or more portions of the road map as a function of historical transit time data associated with the one or more portions of the road map to increase the cost value of portions of the road map associated with higher historical transit time.

16. The method of claim 13, wherein updating the cost value of the one or more portions of the road map comprises:
receiving real-time traffic data through a traffic application programming interface (API);
updating the cost value of the one or more portions of the road map as a function of the real-time traffic data associated with the one or more portions of the road map to increase the cost value of portions of the road map associated with higher traffic data.

17. The method of claim 11, wherein generating the optimized route for the principal vehicle further comprises generating a plurality of alternate routes, wherein generating the plurality of alternate routes comprises:
generating a plurality of routes; and
select a five shortest time routes of the plurality of routes.

18. The method of claim 11, wherein principal vehicle comprises a delivery robot.

19. The method of claim 11, wherein the principal vehicle comprises an autonomous vehicle.

20. The method of claim 11, wherein generating the optimized route as a function of the cost value for the one or more portions of the road map comprises generating the optimized route using an A-star algorithm.
